(19) United States
(12) Patent Application Publication
(10) Pub. No.: US 2003/0011242 A1
(43) Pub. Date: Jan. 16, 2003

(54) Arrangement for estimating the friction between a vehicle wheel and the road

(76) Inventor: Nils-Gunnar Vagstedt, Taby (SE)

Correspondence Address: OSTROLENK FABER GERB & SOFFEN, 1180 AVENUE OF THE AMERICAS, NEW YORK, NY, 100368403

(21) Appl. No.: 10/203,985

(22) PCT Filed: Feb. 13, 2001
(86) PCT No.: PCT/SE01/00280

(30) Foreign Application Priority Data
Feb. 14, 2000 (SE) 0000445-7

(51) Int. Cl. B60T 8/60

(52) U.S. Cl. 303/150

(57) ABSTRACT

The invention relates to an arrangement for a vehicle which incorporates powered wheels (1a-b) arranged on a first axle, unpowered wheels (1c-d) arranged on at least one second axle, an engine unit for the vehicle's propulsion and a brake configuration which includes brake devices which are wheels. The arrangement is designed to estimate the level of friction between the vehicle's wheels and running surfaces. The arrangement incorporates a control unit (11) designed to communicate with at least one of said brake devices in such a way that a first brake pressure is delivered to the brake device concerned for a period of time during the vehicle's propulsion, first means (12) designed to measure the speed of the wheel which the brake device to which said first brake pressure is delivered acts upon during said period of time, and second means (13) designed to measure the speed of a free-running one of said wheels during said period of time, and the level of friction is estimated on the basis of the speed of said braked wheel and the speed of said-free running wheel. This makes it possible for the so-called slip of a braked wheel to be estimated. If the braked wheel runs at a significantly lower speed than the free-running wheel, knowledge of the load prevailing on the braked wheel may be used to describe a function concerning the force configuration of the braked wheel, i.e. resultant forces acting upon the braked wheel, after which the prevailing friction may be calculated.

### BACKGROUND TO THE INVENTION, AND STATE OF THE ART

The present invention relates to an arrangement for a vehicle which is designed to estimate the level of friction between the vehicle's wheels and running surfaces according to the preamble to patent claim 1.

The braking moment engendered in braking a vehicle is usually directly proportional to the force applied to the brake control, e.g. the pedal which activates the braking of the vehicle, so long as the grip on the road is sufficient. Transmitting the force applied to the pedal in conventional trucks involves using pneumatic configurations for applying the respective wheel brakes. In more recent trucks an electrical link is used for transmitting the force applied to the pedal to the brake cylinders of the respective wheel brakes. Compressed air is only used for applying the wheel brakes, which may include disc brakes or drum brakes. Such electrical brake systems often incorporate an ABS unit which for a short time automatically reduces the braking applied when risk of wheel locking arises. Powerful braking entails the risk, particularly on slippery running surfaces, that the braking force delivered to the respective wheel brakes may cause the wheels to lock, i.e. to start sliding over the running surface. This means that it is necessary to brake gently on slippery running surfaces due, for example, to water, oil, ice, snow etc. For friction to develop between tires and running surfaces there has to be a speed difference at the contact surface, what is known as “slip”. Tyres subjected to slip temporarily become elastically deformed. Lock-free braking is used to try to generate maximum friction force between wheels and running surfaces. Knowing the level of friction between running surfaces and tires makes it possible to improve traffic safety substantially.

The vehicle's load also affects the braking moment in that greater vehicle load gives the wheels more grip on the running surface. The total weights of heavy vehicles, e.g. trucks, are increasing, hence also the pressure on their various axles On a heavy vehicle, the pressure on the rear axles is often greater than on the front axle. The total braking force, i.e. the braking force called for by the driver, which is defined by the force applied to the pedal, should preferably be distributed between the front and rear wheels in proportion to the weight they carry. Thus load sensors may be designed to measure the load which acts upon the respective wheels. Electrically controlled brake systems of the type mentioned above usually apply all the wheel brakes simultaneously. However, the brake system may be designed in such a way that the brake pressure delivered to one wheel brake of the vehicle differs from the brake pressure delivered to another wheel brake of the same vehicle, with the object of maintaining vehicle stability. This technique is employed, inter alia, to prevent skidding and overturning of the vehicle if, for example, the brake action called for by the driver on a sharp bend would result in too much brake action on an individual axle, so the brake system may be designed in such a way as to limit the brake action applied.

As mentioned above, there is risk that the brake force delivered to the respective wheel brakes may cause the wheels to lock, i.e. to start sliding over the running surface. This applies particularly during powerful braking and on slippery running surfaces. In more recent trucks using electronics for controlling the braking process as described above, it is possible to control as desired the brake pressure applied to the respective wheel brakes. Thus knowing the level of friction between tires and running surfaces makes it possible to adapt to the prevailing friction level the brake pressure applied to the respective wheel brakes. Moreover, the driver of the vehicle can adapt the force applied to the brake pedal if he/she knows the friction level. However, the arrangements available on the market for detecting the friction prevailing between tires and running surfaces are complicated and expensive, which means that they are not standard vehicle equipment.

### SUMMARY OF THE INVENTION

The object of the present invention is to provide an arrangement whereby it is easy to estimate the level of friction between wheels and running surfaces with a view to improving traffic safety.

This object is achieved with the arrangement indicated in the introduction which has the features defined in the characterising part of patent claim 1.

Such an arrangement, which may incorporate a computer, thus makes it possible to estimate the friction level between wheels and running surfaces. During propulsion of the vehicle a brake device designed to act upon one of the vehicle's wheels delivers a brake pressure via a control unit, followed by the friction being estimated by comparing the speeds of the braked wheel and a free-running wheel. By this comparison the so-called slip between wheels and running surfaces can be estimated.

According to a further embodiment of the invention, estimating the friction level includes taking into account the load bearing upon said braked wheel. If the braked wheel is rotating at a significantly lower speed than the free-running wheel, knowledge of the load bearing upon the braked wheel can be used to describe a function concerning the force configuration of the braked wheel, i.e resultant forces acting upon the braked wheel, and the prevailing friction can then be calculated. If the braked wheel does not reach substantial slip, the load acting upon the braked wheel provides information that the friction prevailing between the wheel and the running surface allows more brake pressure than that initiated by the control unit.

According to a further embodiment of the invention, the arrangement incorporates third means designed to communicate with the control unit in such a way that the control unit receives information about the load bearing upon each of the vehicle's wheels. With advantage, the control unit is designed to deliver said first brake pressure to the brake device which is designed to act upon the wheel which has the lowest prevailing load value The purpose of this is to achieve the least possible tire wear

According to a further embodiment of the invention, the control unit is designed to deliver a supplementary brake pressure to a further one of said brake devices during said period of time, with a view to maintaining the vehicle's stability. It is thus possible, by delivering a supplementary brake pressure to a second brake device, to compensate for the effect of the twisting moment on the vehicle which may result from braking only one wheel. The control unit may be designed to deliver said supplementary brake pressure to the brake device which is designed to act upon the wheel which is arranged about the same axle as the wheel which the brake device to which said first brake pressure is delivered is designed to act upon. Alternatively, the control unit may be designed to deliver said supplementary brake pressure to one of said brake devices which is designed to act upon the wheel which is arranged about one of said axles and is arranged diagonally with respect to the wheel which is arranged on another of said axles and upon which the brake device to which said first brake pressure is delivered is designed to act.

It is of course desirable for the driver of the vehicle to receive friction level information continuously. However, continuous braking of one wheel during propulsion of the vehicle would cause enormous tire wear. One possibility is for said brake pressure to be delivered via the control unit within a certain outside temperature range which may be around 0°. To prevent continuous braking of one wheel within said temperature range, the control unit might be designed to brake one wheel periodically within said temperature range. Another possibility may be for the control unit to be designed to store information concerning previous brakings of the vehicle and for said brake pressure to be delivered via the control unit on the basis of said stored information. A further possibility is for said brake pressure to be delivered via the control unit upon actuation of a control device. This enables the driver of the vehicle to decide for him/herself when to seek friction level information.

According to a further embodiment of the invention, the brake device to which said first brake pressure is delivered is designed to act upon an unpowered wheel

According to a further embodiment of the invention, the engine is designed in such a way that the drive power applied to the vehicle's powered wheels increases in proportion to the vehicle speed reduction caused by the delivery of said brake pressure.

### BRIEF DESCRIPTION OF THE DRAWINGS

The present invention will now be explained on the basis of an embodiment described by way of example with reference to the attached drawings

FIG. 1 depicts schematically a brake configuration for a heavy vehicle and

FIG. 2 depicts schematically an embodiment of an arrangement according to the present invention.

### DETAILED DESCRIPTION OF AN EMBODIMENT OF THE INVENTION

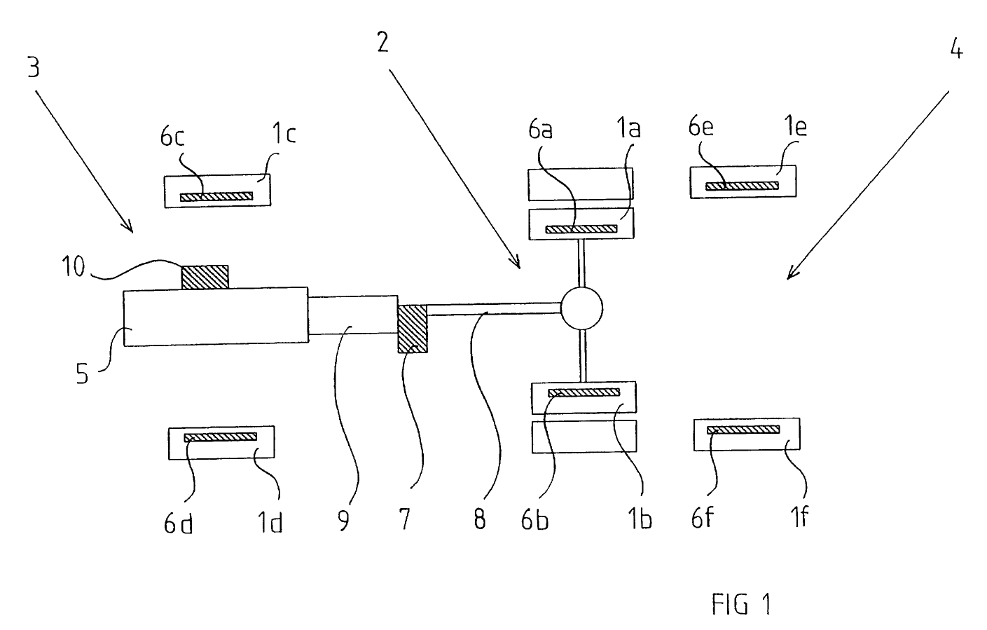

FIG. 1 depicts schematically a brake configuration of a heavy vehicle such as a truck which incorporates powered wheels 1a-b arranged on a first axle 2, and unpowered wheels 1c-f arranged on a second axle 3 and a third axle 4. The vehicle incorporates an engine unit 5 to power the vehicle, and a brake configuration. The brake configuration of the vehicle includes a main brake which incorporates brake devices 6a-f designed to act upon the vehicle's wheels 1a-f. The brake devices 6a-f may include pneumatic disc brakes, and the main brake incorporates the equipment required for applying the brake linings of the respective disc brakes to the brakes which rotate with the respective wheels 1a-f. The brake configuration of the vehicle includes a supplementary brake in the form of a retarder 7 which generates outward braking moment by means of viscous friction. The retarder 7 is connected to the universal shaft 8 and to the vehicle's gearbox 9 and only brakes the powered wheels 1a-b. The vehicle also incorporates a further supplementary brake in the form of an exhaust brake 10 The exhaust brake 10 is connected to the vehicle's engine unit 5

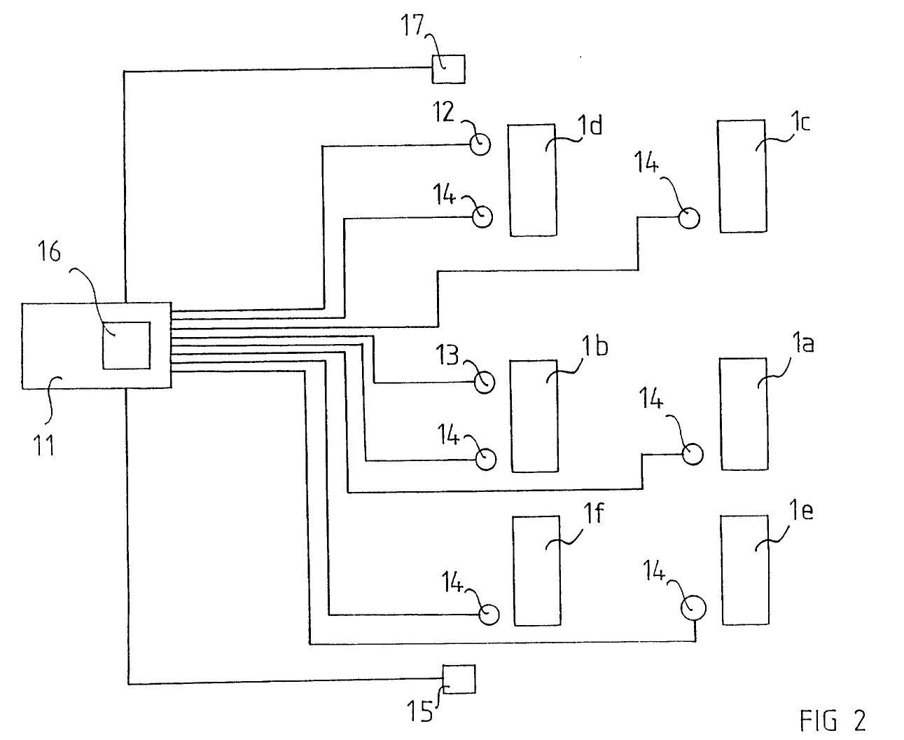

FIG. 2 depicts an arrangement for estimating the level of friction between running surfaces and wheels or, more specifically, between road surfaces and the tires on the wheels of a heavy vehicle such as a truck according to an embodiment of the invention. It should be noted that the arrangement according to the invention is also applicable to other types of vehicle, e.g. passenger cars, other types of freight vehicles, buses and similar utility vehicles. The arrangement includes a control unit 11, first means 12, second means 13 and third means 14 A more detailed description of the function of the control unit 11 and the means 12, 13, 14 follows further on in the description.

The control unit 11, which incorporates a computer, may be designed so as, upon braking of the vehicle, to distribute the brake action called for by the driver to the various brake devices 6a-f (not depicted in FIG. 2), each of which is designed to act upon a respective wheel 1a-f. Alternatively, the control unit 11 may be designed to distribute the brake action called for by the driver partly to the retarder 7 and partly to the brake devices 6a-f. How the control unit 11 is designed to distribute the brake action called for by the driver is not described further in this patent application. It should be noted, however, that the control unit 11 is designed to control the application of the brake configuration's brakes, i.e. the brake devices 6a-f, the retarder 7 and the exhaust brake 10.

We now go on to describe how it is possible to estimate the level of friction between tires and running surfaces by means of the arrangement illustrated in FIG. 2. The third means 14 is designed to communicate with the control unit 11 in such a way that the control unit 11 continuously receives information about the prevailing load on each of the wheels 1a-f. One possibility may be that the third means 14 incorporates sensors (one sensor for each of the wheels 1a-f) designed to detect the suspension pressure for the respective wheels 1a-f, after which the normal force acting upon the respective wheels 1a-f may be calculated by means of the control unit 11. During propulsion of the vehicle the control unit 11 is designed to deliver, during a period of time, a brake pressure of a certain magnitude (this brake pressure being hereinafter called the first brake pressure) to one of the brake devices, thereby braking the wheel which the respective brake device is designed to act upon In FIG. 2, it is the wheel 1d which is braked and hence it is the brake device 6d to which the first brake pressure is delivered. At the same time, the first means 12 is designed to measure the speed of the braked wheel 1d during said period of time. The second means 13 is designed to measure the speed of a free-running wheel during said period of time. In FIG. 2 the free-running wheel takes a form of wheel 1b. Said first means 12 and said second means 13 respectively may be designed to measure the speed of the respective disc brake discs which rotate with the respective wheels 1b, 1d. In addition, the control unit 11 is designed to communicate with the first means 12 and the second means 13 and hence receive information about the speed of the braked wheel 1d and the free-running wheel 1b The control unit 11 compares the speed of the braked wheel 1d and the free-running wheel 1b, and hence the so-called slip of the braked wheel 1d can be estimated. If the braked wheel 1d runs at a substantially lower speed than the free-running wheel 1b, knowledge of the prevailing load on the braked wheel 1d can be used to describe a function concerning the force configuration of the braked wheel 1d, i.e. the resultant forces acting upon the braked wheel 1d, after which the prevailing friction can be calculated. If the braked wheel 1d does not reach substantial slip, the load acting upon the braked wheel 1d provides information that the friction prevailing between the wheel 1d and the running surface allows a higher brake pressure value, i.e. the first brake pressure, than that initiated by the control unit 11.

With advantage, the control unit 11 delivers the first brake pressure to the brake device which is designed to act upon the wheel which has the lowest prevailing load value.

To compensate for the influence of the twisting moment on the vehicle which braking only one wheel may give rise to, the control unit 11 may be designed to deliver a supplementary brake pressure to the brake device 6a of the powered wheel 1a, which wheel 1a is arranged diagonally with respect to the wheel 1d to whose brake device 6d the first brake pressure is delivered. The magnitude of the supplementary brake pressure may differ from the magnitude of the first brake pressure. The magnitude of the supplementary brake pressure to the brake device 6a which is designed to act upon the powered wheel 1a is in proportion to the load acting upon the powered wheel 1a. Alternatively the control unit 11 may be designed to deliver the supplementary brake pressure to the brake device 6c which is designed to act upon wheel 1c.

The delivery of said brake pressure may be effected in various ways. The brake pressure may be applied automatically on the basis of a diagram or as called for by the driver. The delivery of said brake pressure may also be initiated by parameters such as outside temperature (in which case the control unit 11 is designed to communicate with a temperature sensor 15), stored information concerning previous brakings of the vehicle stored in a memory unit 16 in the control unit 11 or via a separate control 17 which can be operated by the driver of the vehicle.

The engine unit 5, which may be connected to the control unit 11, may be designed in such a way that the drive on the vehicle's powered wheels 1a-b increases in proportion to the vehicle's speed reduction caused by the delivery of the first brake pressure and the supplementary brake pressure.

The invention is not limited to the embodiment referred to but may be varied and modified within the scopes of the ensuing patent claims.

1. Arrangement for a vehicle which incorporates powered wheels (1a-b) arranged on a first axle (2), unpowered wheels (1c-d; 1e-f) arranged on at least one second axle (3; 4), an engine unit (5) for the vehicle's propulsion and a brake configuration which includes brake devices (6a-f) which are each designed to act upon one of said wheels (1a-f), the arrangement being designed to estimate the level of friction between the vehicle's wheels (1a-f) and running surfaces, characterised in that the arrangement incorporates a control unit (11) designed to communicate with at least one of said brake devices in such a way that a first brake pressure is delivered to that brake device for a period of time during the vehicle's propulsion, first means (12) designed to measure the speed of the wheel which the brake device to which said first brake pressure is delivered acts upon during said period of time, and second means (13) designed to measure the speed of a free-running one of said wheels during said period of time, and the level of friction is estimated on the basis of the speed of said braked wheel and the speed of said free-running wheel.

2. Arrangement according to claim 1, characterised in that the load prevailing on at least said braked wheel is taken into account in estimating the level of friction.

3. Arrangement according to claim 2, characterised in that the arrangement incorporates third means (14) designed to communicate with the control unit (11) in such a way that the control unit (11) receives information about the load prevailing on each of said wheels (1a-f).

4. Arrangement according to claim 3, characterised in that the control unit (11) is designed to deliver said first brake pressure to the brake device which is designed to act upon the wheel which has the lowest prevailing load value.

5. Arrangement according to any one of the foregoing claims, characterised in that the control unit (11) is designed to deliver a supplementary brake pressure to another of said brake devices during said period of time with a view to maintaining the vehicle's stability.

6. Arrangement according to claim 5, characterised in that the control unit (11) is designed to deliver said supplementary brake pressure to the brake device which is designed to act upon the wheel which is arranged about the same axle as the wheel which the brake device to which said first brake pressure is delivered is designed to act upon.

7. Arrangement according to claim 5, characterised in that the control unit (11) is designed to deliver said supplementary brake pressure to one of said brake devices which is designed to act upon the wheel which is arranged about one of said axles and which is arranged diagonally with respect to the wheel which is arranged on another of said axles and on which the brake device to which said first brake pressure is delivered is designed to act

8. Arrangement according to any one of the foregoing claims, characterised in that the control unit (11) is designed to store information concerning previous brakings of the vehicle, and the timing of the delivery of said brake pressure via the control unit (11) depends on said stored information.

9. Arrangement according to any one of the foregoing claims, characterised in that delivery of said brake pressure via the control unit (11) takes place upon actuation of a control (17).

10. Arrangement according to any one of claims 1 to 7, characterised in that delivery of said brake pressure via the control unit (11) takes place at a certain outside temperature level.

11. Arrangement according to any one of the foregoing claims, characterised in that the brake device to which said first brake pressure is delivered is designed to act upon an unpowered wheel (1c-f).

12. Arrangement according to any one of the foregoing claims, characterised in that the engine (5) is designed in such a way that the drive on the vehicle's powered wheels (1a-b) increases in proportion to the vehicle's speed reduction caused by the delivery of said brake pressure.
